(19) United States
(12) Patent Application Publication
(10) Pub. No.: US 2015/0125252 A1
(43) Pub. Date: May 7, 2015

(54) CRAWLER FOR TRANSPORTING HEAVY LOADS, SYSTEM COMPRISING A PLURALITY OF CRAWLERS AND METHOD FOR TRANSPORTING HEAVY LOADS

(71) Applicant: Nikolaus BERZEN RATZEL, Kloten (CH)

(72) Inventor: Nikolaus Berzen Ratzel, Kloten (CH)

(21) Appl. No.: 14/405,796

(22) PCT Filed: May 27, 2013
(86) PCT No.: PCT/EP2013/060885

§ 371 Date: Dec. 5, 2014

(30) Foreign Application Priority Data
Jun. 5, 2012 (DE) 20 2012 102 062.9

(51) Int. Cl. B60P 1/02; B62D 55/06; B60P 3/40

(52) U.S. Cl. CPC B60P 1/02; B60P 3/40; B62D 55/06
USPC 414/800; 254/2 R

(57) ABSTRACT

A crawler for transporting loads, having at least two chain drive units (12a, 12b) and a bearing unit (16) on a chassis (14) between the chain drive units (12a, 12b), to a system comprising a plurality of crawlers of this type and to a method for transporting loads. In order to provide a crawler, and a system and a method, by means of which very large loads can be transported simply and exactly in a controllable manner, the bearing unit has a load pickup (20) for a load to be transported, and has a hoist cylinder (18) having a piston (19) for adjusting the height of the load pickup (20). The hoist cylinder and the piston (19) are mounted to the bearing unit (16) in a rotationally locked manner, wherein the load pickup (20) is coupled to the hoist cylinder (18) by way of a ball and socket connection (22, 24) such that a rotational and swivel movement between the load pickup (20) and the bearing unit (16) is possible, and that a rotary sensor (27) is provided in order to determine an angle of rotation between the load pickup (20) and the piston (19) or the hoist cylinder (18).

The invention relates to a crawler for transporting loads and a system and a method for transporting loads with a plurality of crawlers. In particular, the transport of particularly heavy loads of more than 500 t is thereby addressed.

One area in which the transport of such large loads is required on a regular basis is the construction of offshore facilities, for example platforms for offshore wind parks. Structural elements for such facilities are normally manufactured in fabrication locations near the coast, but then must typically be transported over a distance of a few hundred meters for loading.

In particular, the use of SPMTs, i.e. heavy-load vehicles with wheels mounted in pairs on individual axles, is known for these types of large loads. Such SPMTs are configured with sufficient load-bearing capacity, in particular with an appropriate number of axles, for the respective load to be transported.

However, a suitable ground surface is necessary for the use of SPMTs. The costs for the construction of such an infrastructure, i.e. of smooth, load-bearing ground surfaces, are thereby considerable.

U.S. Pat. No. 4,222,581 describes a method and an apparatus for moving large objects, in which four crawler transporters are placed in a rectangular or trapezoidal arrangement below the object. Each of the crawler transporters thereby has two chain drives and one hydraulic hoisting system, wherein the load is mounted on a relocatable mounting. The hydraulic pressure of two lifting systems is thereby balanced through a connection of the hydraulic systems so that two independent load bearings act effectively like a single bearing point. The load is transported in that respectively one driver in each of the crawler transporters controls it so that the crawler transporters are moved in a coordinated manner simultaneously in the same direction.

US 2010/0126790 describes a transporter, which has a plurality of axle-chain units, each of which is arranged in a rotatable manner on a frame. The transporter has a power unit with a combustion engine and a central controller. The axle-chain units each comprise an electrical drive and are connected with a bearing plate on the bottom side of the transporter, which is arranged on the end of a hydraulic cylinder. The cylinder housing of the hydraulic cylinder is mounted in a swivelling manner in an axle frame of the axle-chain unit on a bearing pin, in order to compensate for unevennesses. The transporter is controlled by a wireless user interface so that it executes desired movements in the linear forwards direction, at a right angle to its longitudinal axis or diagonally. In the case of a lifted load, the hydraulic cylinders are respectively extended approximately to a middle position so that a compensating suspension function is realized in that the hydraulic cylinders are respectively extended or retracted in order to compensate for the unevennesses of the ground. During the drive, a control computer calculates the control algorithms for the respective axles and supplies them with control signals.

DE 2153492 describes a transport device for heavy open pit mining devices that do not have their own chassis. Disks, which carry the cylinder of a hydraulic pressure power-transmission system in a vertical arrangement, are attached to a front side of a frame of the device to be transported. The cylinder can be permanently attached to the frame of a crawler vehicle, wherein a piston rod on its end protruding upwards out of the cylinder carries a ball and socket joint. This can be inserted from below into a ball socket in a disk sitting on the frame of the device to be transported. For the forward movement of the heavy device, the crawler chassis are fastened by means of the cylinders and the support balls or respectively the ball socket and first lifted from the floor. The crawler chassis can then be turned around the middle lines of the cylinders in the direction corresponding with the intended forward movement of the device. After lowering of the piston rods, the crawler chassis are placed on the ground and can move the heavy device forward together through an even drive.

U.S. Pat. No. 3,612,312 describes the handling of particularly heavy loads, in particular of ship parts with a mass for example of 1,000 t. For the transport, a number of vehicles are combined, which have lift- and lowerable hoisting means in the form of telescopically extendable pressure medium pistons.

The object of the invention is to suggest a crawler and a system as well as a method, with which very large loads can be transported simply and exactly in a controllable manner.

This object is solved by a crawler according to claim 1, a system according to claim 11 and a method according to claim 15. Dependent claims relate to advantageous embodiments of the invention.

According to the invention and a first aspect, an individual crawler for the transport of loads is provided, which, as will be explained below, is suitable for use in a system or method with a plurality of same or similar crawlers.

The crawler has two preferably parallel chain drive units. Through a chain or crawler drive, a good load distribution results on the ground, whereby any compacted ground surface is suitable. The chain drive units comprise preferably respectively one or more driven chain wheels, wherein at least two chain wheels are connected with the drive chain on each side.

Furthermore, the crawler comprises a bearing unit between the chain drive units. The advantageously centrally arranged bearing unit has a hoist cylinder, preferably a hydraulic cylinder, with a piston, with which the height of a load bearing coupled with it is adjustable so that the load bearing can be lifted or respectively lowered by retracting or extending the piston, for example in order to lift or lower the load or in order to adjust the height of a lifted load. In a further embodiment, the hoist cylinder can also apply tractive forces, for example in order to lift the crawler.

According to the invention, the load bearing is thereby not rigidly connected with the piston, but is rather connected with the hoist cylinder by way of a ball and socket connection such that rotational and swivel movements are possible between the load bearing and the bearing unit.

A ball and socket connection is understood as any coupling, in which two curved surfaces lie on top of each other such that they can execute the described relative movements, i.e. a rotational movement around the longitudinal axis of the hoist cylinder as well as swivel movements around axes mainly at a right angle to the longitudinal axis of the hoist cylinder. The ball and socket connection coupled with the piston preferably comprises a rounded carrying surface. This is preferably partially ball shaped, in particular preferably at least hemispherically shaped, but other rounded shapes are also generally possible. A suitable socket, i.e. a concave carrying element with a preferably rounded inner surface, is placed on the carrying surface on the side of the load bearing such that the described rotational and swivel movements are possible in the case of further good, preferably planar, contact between the carrying surface and socket. The loading of the carrying and socket surfaces is reduced by the preferably planar support, and the mobility under load is increased.

Through the rotatable and swivelling connection of the load bearing with the chassis of the crawler, it is possible that the crawler supports the load at its load bearing and lifts and carries it by means of its hoist cylinder, but thereby remains mainly freely moveable in this alignment. In particular, the crawler can execute a rotation around a vertical axis with respect to the load in the case of a borne load by a different drive of the chain drive units. In particular, for the case of ground unevennesses and slopes, the crawler always remains securely coupled to the load via the swivelling connection.

According to an advantageous aspect of the invention, the hoist cylinder and the piston are attached in a rotationally locked manner on the bearing unit. In a preferred design, the hoist cylinder is permanently attached to the bearing unit and the load bearing is coupled with the free end of the piston. The piston is received in a rotationally locked manner in the hoist cylinder, i.e. for example through the form-fitting mounting with a non-round cross-section. The piston particularly preferably has at least one, preferably several, longitudinally running projections or recesses, with which it is mounted in the hoist cylinder in a form-fitting manner and through which a rotation is excluded.

The twist-proof attachment ensures that a twisting of the crawler for load bearing and thus also for the load itself can only take place in the ball and socket connection.

According to a further advantageous aspect of the invention, a rotary sensor (angle sensor) is provided for this twisting in order to determine the angle of rotation between the load bearing and the piston or hoist cylinder.

The alignment of the crawler relative to the load is thus determined by the rotary sensor. It can thus be determined in which alignment the driving direction of the crawler is relative to the transported load. This information is particularly important in an automatic control of the transport of a load by a crawler, and in particular by several crawlers. The angle of rotation delivered by the rotary sensor can be used for example in a controller, in which a desired angle of rotation is specified and a drive of the chain drive units takes place such that the desired angle of rotation is set in order to enable a transport of the load in this direction.

Different types of sensors can be used for the rotary sensor, in particular known sensor types according to mechanical, potentiometric, inductive, capacitive or optical measurement principles.

According to a further embodiment of the invention, the rotary sensor is designed such that a capturing of the angle of rotation is enabled despite a swivel movement between the crawler and the load, i.e. also between the load bearing and the hoist cylinder. For example, the rotary sensor can have a first and a second sensor part. The first sensor part is coupled with the hoist cylinder or the piston in a torque- and swivel-proof manner, while the second sensor part is coupled with the load bearing in a torque- and swivel-proof manner. The first and second sensor parts are rotatable and swivelling with respect to each other. The sensor is designed such that the angle of rotation of the sensor parts is determined relative to each other without impeding the swivel movement, and preferably such that a swivel movement at least mainly does not impact the determination of the angle of rotation.

For this, in a particularly preferred design, at least one coupling element can be provided, which is arranged in a swivel-proof but rotatable manner with respect to one of the sensor parts and in a torque-proof but swivelling manner with respect to the other sensor part.

A cardanic coupling on the rotary sensor is particularly preferred. This establishes a torque-proof but swivelling connection with one of the involved elements—i.e. the load bearing or the piston—so that a capturing of the angle of rotation can take place independently of a swivel movement. For example, a coupling element can also be suspended cardanically on a sensor part so that it is coupled with it in a torque-proof but swivelling manner. The final determination of the sensor value can take place for example through an analysis unit arranged on the first sensor part, which determines the relative rotary position of the first sensor part or the coupling element, for example inductively.

The ball of the ball and socket connection preferably has a form-fitting mounting in the socket. It is hereby enabled that the socket surrounds the ball head in a captive manner, i.e. such that a lifting of the socket from the ball head is excluded due to the form-fit. According to a further embodiment of the invention, such a form-fit is fulfilled by a safety element, for example a multi-part locking ring. It is hereby also possible that not only compressive forces but also tractive forces can be transferred via the ball and socket connection when carrying a load. The form-fitting mounting can be ensured for example through a ball head that comprises more than a hemisphere, i.e. an angular area of more than 180° in cross-section.

The movement of the ball and socket connection can thereby take place mainly freely without a resetting or respectively dampening element; however, a flexible resetting and/or dampening element can also be provided, which counteracts in particular a swivel movement of the load bearing. This can thereby be a spring element, which is arranged such that it is compressed out of the (preferably horizontal) basic position in the case of a swivel movement and thereby applies a force directed opposite the swivel movement. This can be ensured for example via a resetting or respectively dampening ring, which is arranged between an upper surface connected with the load bearing and a lower surface connected with the chassis or respectively with the hoist cylinder. The ring can be made of a flexible material, for example an elastomer. Such an element ensures that the load bearing always remains in the basic position without strong, acting forces and that a counterforce always acts against a swivel movement.

In addition to the rotary sensor, additional sensors may preferably be provided on the crawler, which can be used on one hand to monitor the operation and on the other hand also in connection with an automatic or semi-automatic controller. According to a further embodiment, a load sensor can be provided for determining the applied load. The load sensor can be designed for example as a load measuring cell. Furthermore, a path sensor is preferably provided for determining the stroke travel, i.e. for determining the path by which the piston is extended from the hoist cylinder.

According to a further embodiment of the invention, a control unit is provided on the crawler. This preferably is a programmable, electronic controller, for example with a microprocessor and memory for an operating program. On one hand, the hoist cylinder can be controlled by the control unit. On the other hand, the chain drive units can be driven, in particular in a separate activation in order to enable curved travel or rotations in addition to straight travel.

The control unit on board the crawler is preferably programmable so that it controls for example the chain drive units and the hoist cylinder according to a control program.

The central, intelligent controller is preferably programmed such that it analyses and processes for example sensor data from one or several sensors located on board, for example from the angle sensor, from a load sensor and/or path sensor on the hoist cylinder as well, if necessary, additional sensors such as e.g. position sensors, e.g. a tilt sensor, in particular for the horizontal alignment (spirit level) and/or a gyro compass as well as from sensors on the chain drive units, e.g. speed sensors and/or pressure or respectively flow-through sensors for determining the respective driving position, driving speed, etc.

According to a further embodiment of the invention, the crawler has a communication device for transmitting and/or for receiving control values, e.g. target values or actual values (sensor data), different control variables and/or control commands.

More preferably, the intelligent controller communicates via the communication device, e.g. in order to transmit sensor data calculated on board or to receive sensor data or target values from an external source (e.g. from a central controller or from other crawlers in a system, see below). Control commands can also be transmitted or received via the communication device, as will be explained in greater detail below. The communication device can thereby be in principle any form of a wireless or cable-bound electrical interface. It is preferably designed as a digital data interface, for example cable-bound as a network interface (Ethernet) or wireless, for example as a digital radio interface, e.g. WLAN.

According to a further embodiment of the invention, a hydraulic system is provided on the crawler. The hydraulic system comprises at least one, preferably several, hydraulic pumps as well as preferably a pressure reservoir. Furthermore, the hydraulic system preferably comprises controllable valves for activating or deactivating different hydraulic actuators. In particular, the hoist cylinder can be operated hydraulically by the hydraulic system. The chain drive units are driven by at least one motor arranged on the crawler, wherein in principle different types of motors like electric motors or combustion engines etc. come into question. The chain drive units are preferably driven by hydraulic motors, which are operated with the hydraulic system. At least one hydraulic pump of the hydraulic system is preferably driven with a combustion engine, in particular a diesel engine, more preferably via intermediate gears. In a preferred embodiment, a motor drives several separate hydraulic pumps, e.g. respectively separately for the driving motors and for the hoist cylinder, even more preferably also an additional filling pump, via a transfer gearbox. Furthermore, it is particularly preferred that each of the chain drive units has a separate drive.

According to a further embodiment of the invention, a motor, in particular a combustion engine, is preferably provided on the crawler with a sound protection system. The sound protection system is particularly preferred as a housing around the motor, within which more preferably one or more hydraulic pumps can be arranged, which are preferably coupled to the motor with an intermediate gearbox. Particularly preferably, hydraulic lines thereby run like hoses within the housing, which act as sound protection elements and absorb a portion of the sound generated by the motor as well as by the pumps.

In addition to the individual crawler, the subject matter of the invention is also a system and a method executed using it for transporting loads, in which a plurality of crawlers are used as described above. The crawlers thereby jointly pick up a load to be transported. This can take place directly in that the load to be transported is connected directly with the load bearing at suitably selected support points (wherein a simple placement is sufficient but a permanent attachment, e.g. through a screwed connection or a releasable lock, is preferred). But it is also possible that the plurality of crawlers carries the load indirectly in that the load bearings engage on a support frame or frame for the actual load. The number of crawlers used will thereby depend on the weight and the geometry of the load to be transported. Even if only two crawlers are used, an advantageous, versatile system thereby results from the flexible structure with the rotatable and swivelling load connection. With three crawlers, the system has a robust, easily controllable three-point mounting of a load. However, a considerably larger number of crawlers can also be used in the network, e.g. up to 40 crawlers, for transporting one extremely large load.

In the system according to the invention, the crawlers communicate with each other via the communication devices. This communication can be used on one hand in order to effectuate a movement of the network of crawlers and thus also of the borne load through coordinated activation of the respective chain drive units, for example a linear advance, rotation or cornering.

On the other hand, the position of a load jointly borne at the load bearings can be balanced via the communication of the crawlers. Examples of this will be discussed below.

This type of system with a plurality of crawlers can be used very flexibly for a large number of different loads. Suitable bearing points on the respective load are thereby defined for the direct or indirect mounting. Then—depending on the bearing load—either an individual crawler or a network of several, e.g. three crawlers, can be used at each bearing point. Examples of this will be explained in the connection with the exemplary embodiments.

According to a further embodiment of the invention, control values for the angle of rotation are transmitted to the crawlers via the communication devices. The controller of the crawlers is then preferably designed such that it controls the chain drive units such that the control value of the angle of rotation is reached at the load bearing. Through the specification of the alignment of each crawler relative to the load, a simple guiding in the network and joint movement is thus possible, e.g. for linear travel, in which the control values are to specified identically, so that the crawlers are aligned the same. The control values can also be specified in a manner that enables cornering or rotation of the load on the spot.

If the crawlers have load sensors for the loads borne by the hoist cylinders, an activation of the hoist cylinders can take place based on the measured load values of the individual crawlers such that e.g. skewed positions are counterbalanced. If, e.g. during travel, one of the crawlers drives through a ground depression, its hoist cylinder will experience a load reduction and the hoist cylinders of the other crawlers will experience an increase. The absolute values or the changes in the respective load can be transmitted via the communication devices so that a calculation for the possible balance can take place in the on-board controller of a crawler or of the on-board controller of several crawlers, or preferably in a central controller, which is then transmitted to the individual crawlers, e.g. through transmission of control commands, e.g. load target values, via the communication devices. Thus, in the example shown, the offloaded crawler can then further extend its hoist cylinder until a load balance is achieved again.

According to a further embodiment of the invention, at least one position sensor is provided in particular for the horizontal position of the load and the hoist cylinders of the crawlers are activated such that the position of the load is counterbalanced. For example, one or preferably two tilt sensors can be provided on the load, wherein the crawlers are controlled such that the transport of the load also always takes place horizontally in the case of a tilted or uneven ground surface. Additionally or alternatively, a position sensor, i.e. in particular a tilt sensor and/or a gyro compass, can also be provided on one or several of the crawlers. Additional sensors, e.g. a wind measuring unit, can also be provided on the load and/or on one or several of the crawlers, in order to counterbalance the effects of the wind during the transport of heavy loads through the corresponding activation of the hoist cylinders.

In the case of the use of the system according to the invention, the crawlers can engage on one hand with the load completely independently of each other so that they are only coupled with each other via the load. But it is also possible that the crawlers do not carry the load directly but rather a frame or a support frame or that tie bars are provided for maintaining the alignment between the load bearings of the crawlers. In the latter case, no support frame would be formed by the bars, since the load would continue to be borne on the load bearings of the individual crawlers and the tie bars would only serve for alignment and would not carry the load. On the other hand, in the case of a support frame or a scaffold, the load is borne on carriers, which rest in turn on the load bearings.

Embodiments of the invention are described in greater detail below based on drawings. The drawings show in:

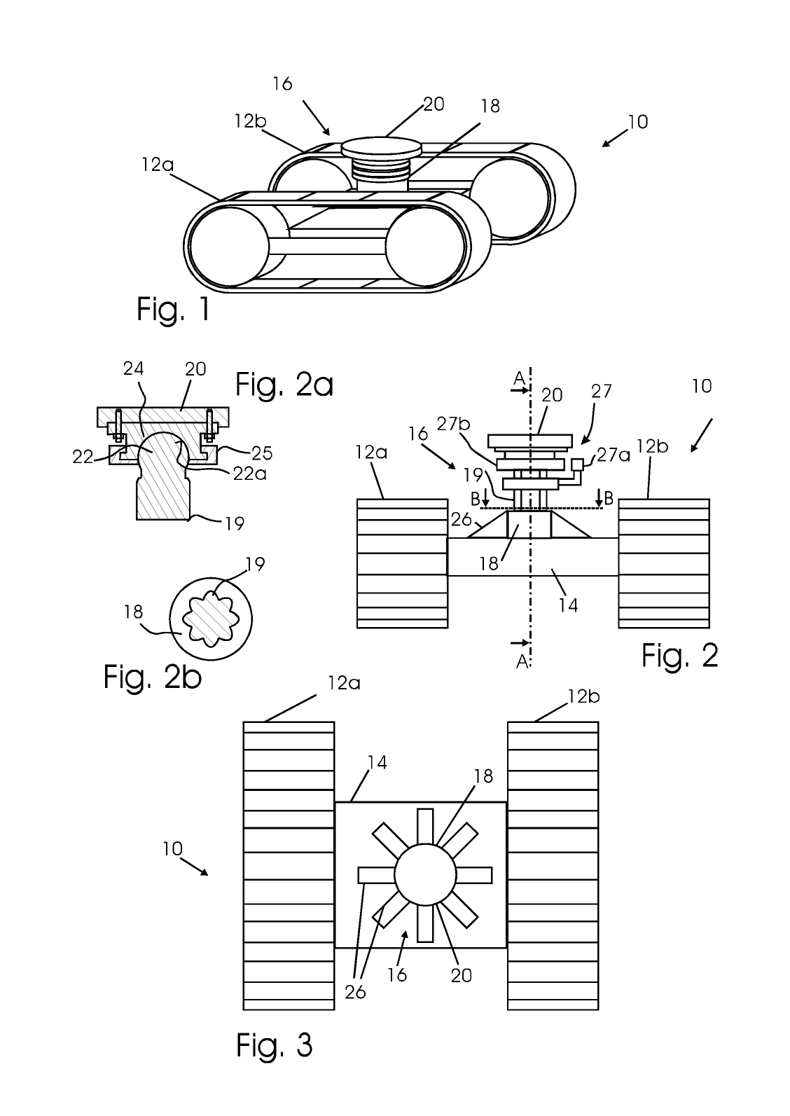

FIG. 1 in a perspective representation, a first, partially schematically represented embodiment of a crawler;

FIG. 2 a front view of the crawler of FIG. 1;

FIG. 2a a sectional view of the load bearing of the crawler of FIG. 1, FIG. 2, wherein the cut is shown along the line A . . . A in FIG. 2;

FIG. 2b a sectional view of the hoist cylinder of the crawler of FIG. 1, 2, wherein the cut is shown along the line B . . . B in FIG. 2;

FIG. 3 a top view of the crawler of FIG. 1, FIG. 2;

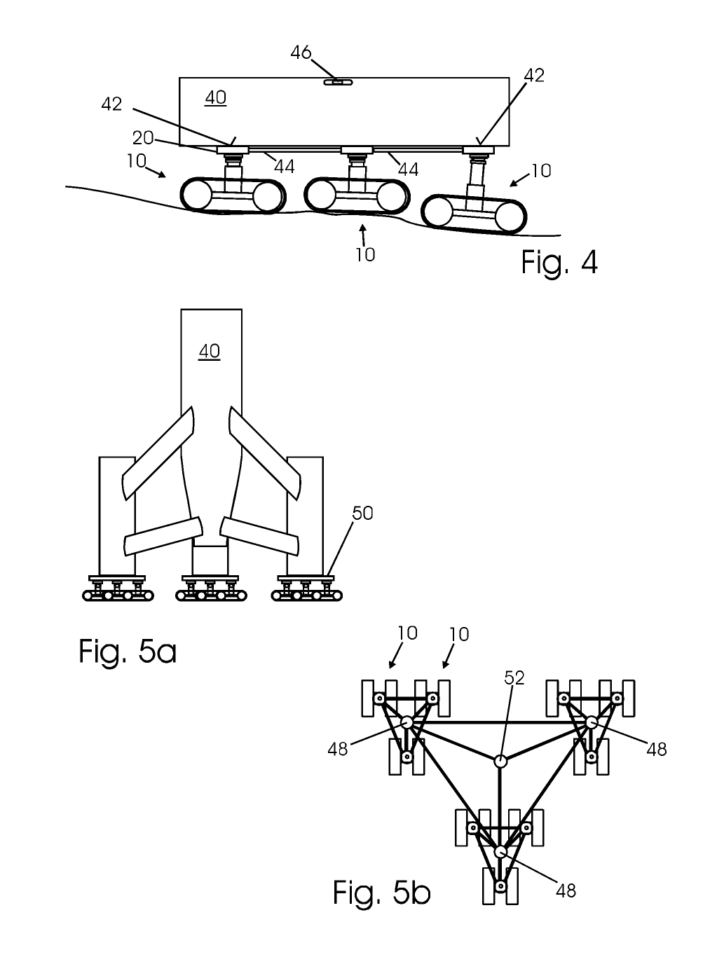

FIG. 4 a partially schematic representation of a system for transporting a load with several crawlers;

FIG. 5a a system for transporting a load with nine crawlers in a side view; FIG. 5b a symbolic representation of the system of FIG. 5a;

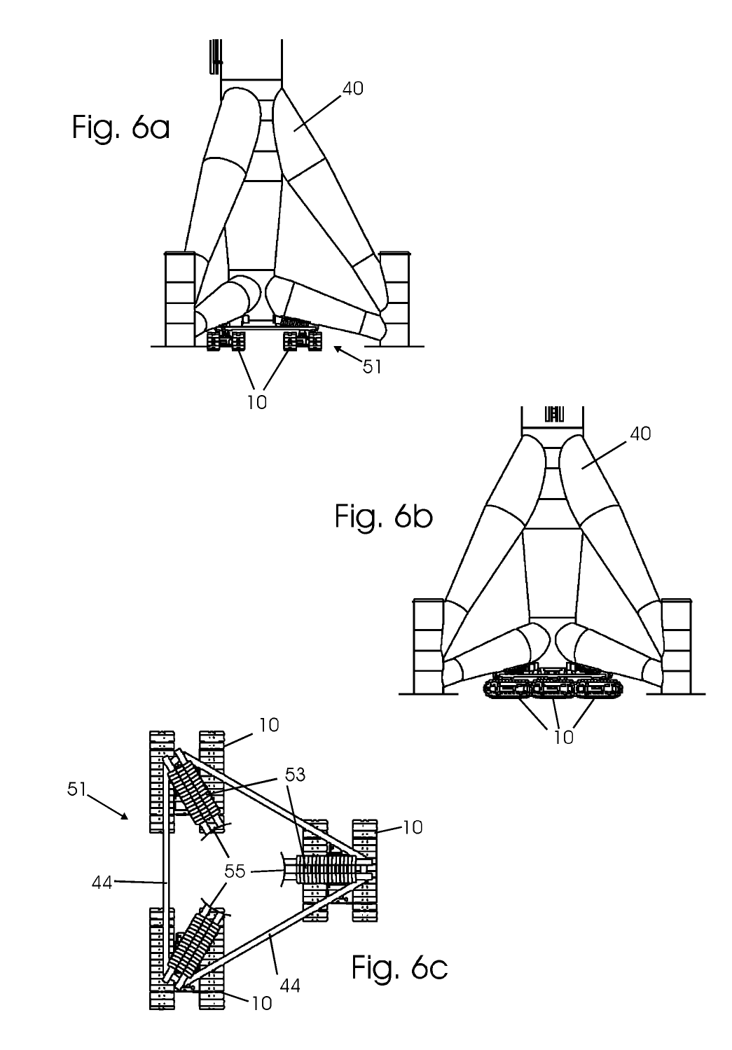

FIG. 6a-c an alternative system for transporting the load of FIG. 5a, 5b with three crawlers and a supporting frame;

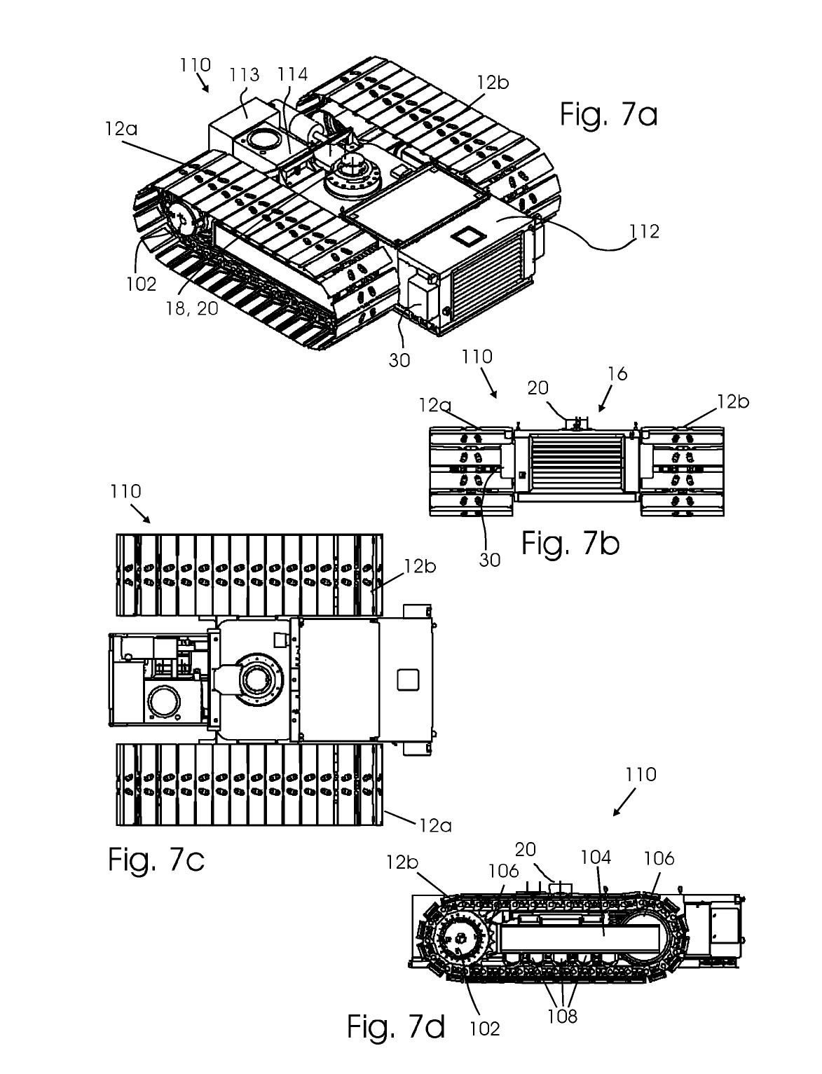

FIG. 7a-d a second embodiment of a crawler in a perspective view, front view, top view and side view;

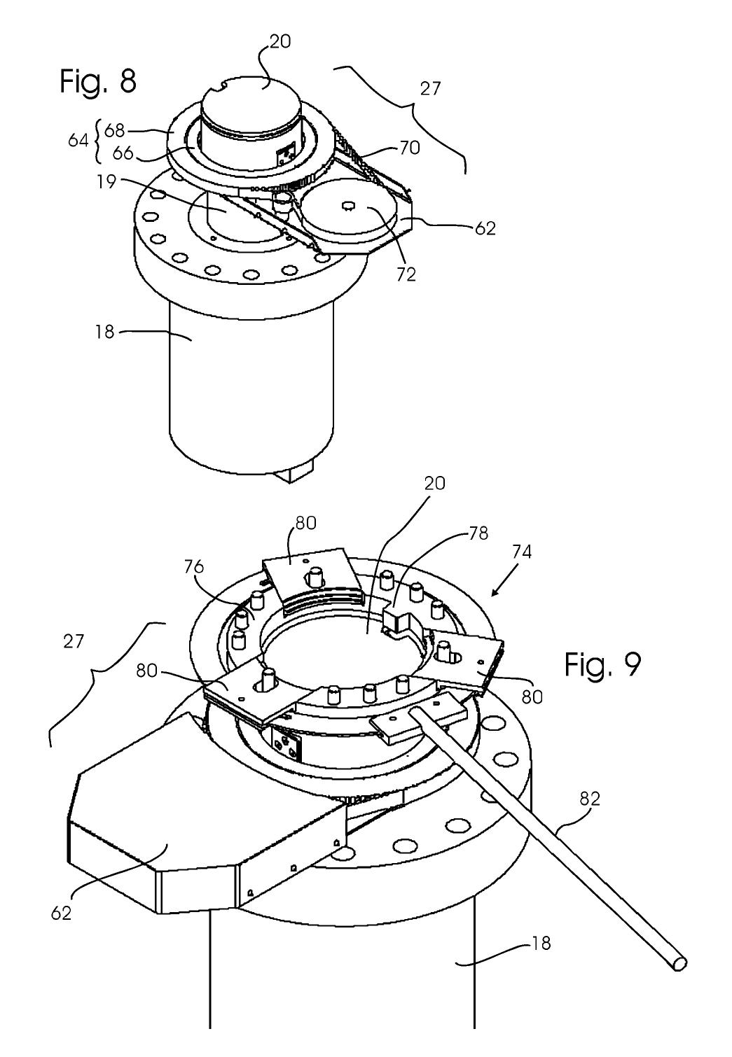

FIG. 8, 9 perspective views of the load bearing of the crawler of FIG. 7 a-d with an angle of rotation sensor;

FIG. 10 in a schematic representation, the top view of a system for transporting loads with nine crawlers;

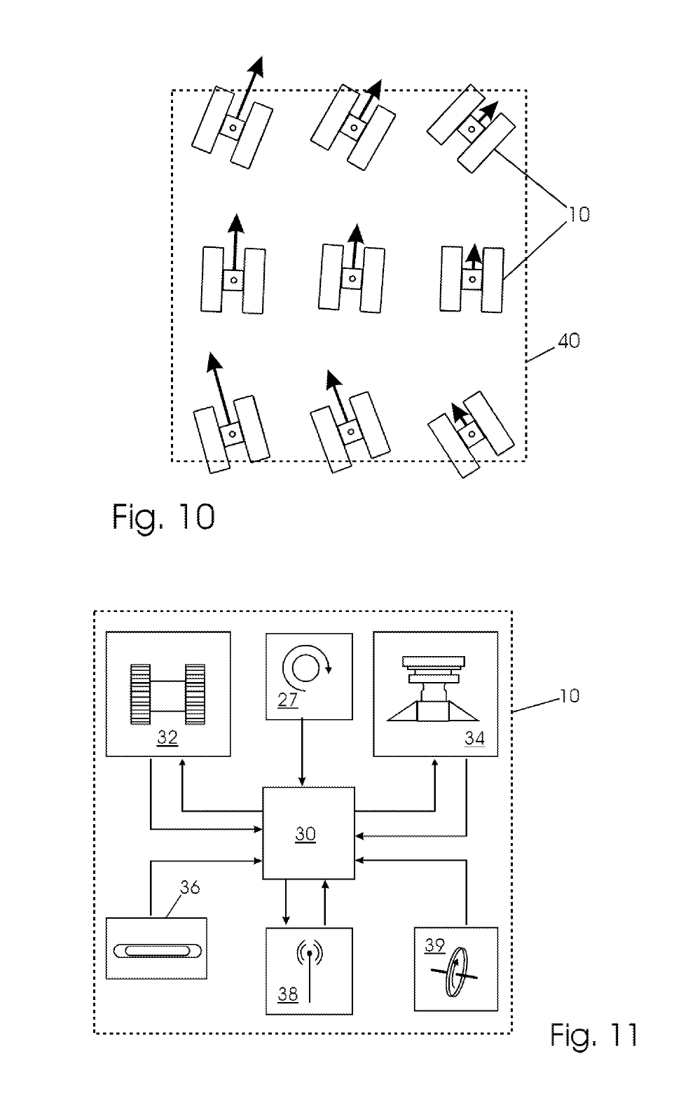

FIG. 11 a block diagram of functional components and the controller of a crawler and

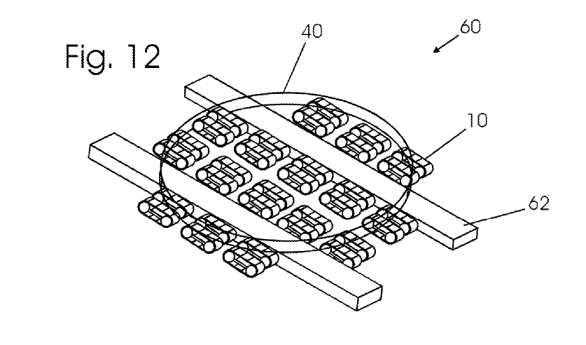

FIG. 12 another example of a system for transporting a load with several crawlers.

FIG. 1-3 show a simplified, partially schematic representation of the basic structure of a crawler 10. It has two chain drive units 12a, 12b arranged next to each other, which are arranged on a chassis 14. A bearing unit 16 is attached to the chassis 14 with a hydraulic hoist cylinder 18 with an extendable piston 19 and a load bearing 20 attached to its end. The crawler 10 is provided for transporting heavy loads, as will be explained in detail below. It thereby carries—if necessary, together with the other crawlers—the load placed on the load bearing 20.

The crawler 10 is drivable by the drive of the chain drive units 12a, 12b as well as controllable in its travel by separate activation of the chain drive units 12a, 12b. The bearing unit 16 is thereby arranged centrally so that e.g. in the case of a reverse operation of the chain drive units 12a, 12b, a rotation of the crawler 10 takes place around the load bearing 20.

The hoist cylinder 18 is designed as a hydraulic cylinder so that its piston 19 is extendable when pressurized. To lift a load, the crawler 10 can be driven under a load bearing point, whereupon then the bearing and a lifting of the load take place by extending the hoist cylinder 18.

The piston 19 is locked in the hoist cylinder 18 in a rotationally locked manner. As can be seen in the sectional representation in FIG. 2b, it has for this a non-circular cross-section with a number of longitudinally extending bulges. The cross-section is received and guided in a form-fitting manner in the piston 18 so that the piston 19 can be retracted and extended. The rotational position of the piston 19 with respect to the cylinder 18 and thus with respect to the chassis 14 and the rest of the crawler 10 is always permanent due to the rotationally locked mounting.

The coupling between the hoist cylinder 18 with its piston 19 and the load bearing 20 takes place via a ball and socket connection. As shown in the sectional representation in FIG. 2a, the end of the piston 19 has a (partial) ball 22 with corresponding (partial) ball surface 22a, onto which a hollow socket 24 is placed. The load bearing 20 is a round adapter plate, which, as will be explained in detail below, is provided for bearing the load. It can thereby be coupled with the load through simple placement; however, a connection to the load acting on both sides is also possible, e.g. through screwing, clamping, etc. A locking of the load bearing 20 to the load is particularly preferred, as will be explained below in terms of FIG. 9.

The load bearing 20 is screwed with the socket 24 in the example shown. In order to secure the socket 24 on the ball head 22, a locking ring 25 is provided, which is coupled in a form-fitting manner with an outer flange of the socket 24 and has an inner opening for receiving the ball head, wherein the diameter of the inner opening is less than the ball diameter. The ball 22 is hereby enclosed over an angle area in the shown section of more than 180°, here e.g. approx. 210°. The ball 22 is thus received in a form-fitting manner in the combination made up of the locking ring 25 and the socket 24 and secured there.

The locking ring 25 is designed as a collar made up of two half shells that are screwed together.

Through the interconnecting shape of the ball surface 22a and the hollow-ball-like inner surface of the socket 24, mobility of the ball and socket connection is given in the case of simultaneously always planar mounting.

The ball and socket connection thus enables on one hand a twisting of the load bearing 20 and thus of the borne load with respect to the hoist cylinder 18 and thus with respect to the chassis 14 of the crawler 10. On the other hand, a swivel movement is also possible so that, e.g. during transport in the case of ground unevennesses, a skewed position of the chain drive units 12a, 12b and of the chassis 14 can occur while the load bearing 20 and thus the borne load remain in horizontal alignment.

Since in this case, in addition to the axial bearing forces, lateral forces also act on the hoist cylinder 18, the hoist cylinder 18 is embedded deep in the chassis 14 and is also connected with the construction by a tensioning ring (not shown) below the middle structure. Thus, considerable lateral forces can be absorbed, which equal e.g. more than 30% of the total load. The hoist cylinder 18 preferably protrudes from the chassis 14 by less than 25% of its hoist height.

A sensor 27 is provided in order to determine the rotational position of the load bearing 20 relative to the piston 19, hoist cylinder 18 and the rest of the crawler. As shown only schematically in FIG. 2, the sensor comprises a first sensor part 27a, which is connected with the hoist cylinder 19 in a torque- and swivel-proof manner, and a second sensor part 27b moveable with respect to the first sensor part 27a, which is connected with the load bearing 20 in a torque- and swivel-proof manner. In the case of a rotation of the crawler 10 with respect to a load borne at the load bearing 20, the rotation takes place in the ball and socket connection so that a rotational movement results between the sensor parts 27a, 27b. This is captured by the sensor 27 and relayed as an electric sensor value. In the specific implementation of the sensor 27, e.g. the second sensor part 27b, can be designed as a gearbox and the first sensor part 27a as an inductive sensor, with which the passing teeth of the second sensor part 27b are counted and an angle of rotation is thus determined. Additional potential designs of sensors are generally known to a person skilled in the art; moreover, another embodiment of a sensor 27 will be explained in detail below.

The crawler 10 has—not shown in FIG. 1 to FIG. 3—on board two separate hydraulic drive motors for the chain drive units 12a, 12b and a hydraulic system for operating the motors as well as for extending the hoist cylinder 18. This and all other functions of the crawler 10 are controlled by a crawler controller 30.

FIG. 11 shows the structure of the different functional units on board the crawler 10 in the form of a block diagram. The crawler controller 30 is a microprocessor controller on board the crawler 10, which executes a control program. It is connected electrically with a drive controller 32 for the chain drive units 12a, 12b.

The drive controller 32 assumes activation of the chain drive units depending on the desired mode of driving specified by the crawler controller 30. It reports the respective driving position as well as the covered path for each side to the crawler controller 30 via suitable sensors for the movement of the chain drive units. The controller determines the revolutions of each individual drive and balances or respectively corrects the speeds so that the speeds are synchronized. In order to correct the synchronized speed, or respectively for cornering, the drive power of the chain drive units is interchanged. The crawler controller 30 thereby processes different sensor signals as explained below in order to set a predetermined driving vector, i.e. a driving direction and a driving speed.

Furthermore, the crawler controller 30 controls a hoist controller 34, with which the hydraulic device for extending and retracting the piston 19 is actuated. On one hand, hoist cylinder 18 returns a position signal from a path sensor for the driving position of the piston 19 via a sensor and, on the other hand, a load signal to the crawler controller 30 via a load measuring cell.

The crawler controller 30 also receives the sensor signal of the angle sensor 27 for the alignment of the crawler relative to the load.

Furthermore, the crawler controller 30 processes sensor signals of additional sensors on board the crawler 10, e.g. two tilt sensors 36, with which the position of the crawler 10 can be determined with respect to the perpendicular as well as of a gyro compass 39, with which the alignment of the crawler 10 is identifiable.

Furthermore, the crawler 10 has a communication device 38, a wireless digital interface in the example shown.

As shown below, a load 40 can be jointly accepted and transported in a network of several crawlers 10. Each crawler 10 is thereby a self-sufficient vehicle with the crawler controller 30. Within a network, a crawler 10 is selected as the main crawler; an operating panel (not shown) is attached to this crawler. This operating panel is thereby preferably housed in a separate device, e.g. in a manual operating device that can be carried by a human operator, and is in constant data connection with the crawler controller 30 of the main crawler 10. The crawler controller 30 of the main crawler 10 thereby becomes a central controller for the network of crawlers 10. The crawler controllers 30 of the other crawlers 10 are connected with the main crawler 10 via the data interface and receive their control commands from there. FIG. 4 shows schematically a system for transporting a load 40, in which as an example three crawlers 10 carry the load 40 at bearing points 42. Tie bars 44 are thereby arranged between the load bearings 20 of the crawlers 10 in order to thus determine the alignment of the crawlers 10 and of the load bearings 20 with respect to each other. However, the strut 44 does not hereby receive the forces required to lift the load.

The load 40 is supported on the load bearings 20 of the crawlers 10. By operating the chain drive units, the crawlers 10 are driven and the load is thus transported. As shown schematically in FIG. 4, unevennesses in the path of travel are thereby evened out. On one hand, smaller unevennesses are already evened out by the large mounting surface of the chain drive units 12a, 12b—the crawlers 10 are respectively all-terrain and do not require a specially prepared path of travel. On the other hand, unevennesses are evened out as shown also through swivel movements of the ball and socket connection between the hoist cylinders 18 of the crawlers 10 and the load bearings 20.

For straight travel, fixed default values for the angle of rotation with respect to the load bearing 20 are thereby specified to the crawlers. In the case of deviations, the respective controller 30 of the crawlers can change the advance of the chain drive units so that the desired default value is reached.

FIG. 4 shows how the ever horizontal transport position of the load 40 is achievable even with inclines in the path of travel by controlling the hoist cylinder 18. A tilt sensor 46 is hereby attached to the load 40. The signal of the tilt sensor 46 is analysed by the central controller (not shown). The central controller thereby communicates with the crawlers 10 via the interface 38 and thus ensures that the hoist cylinders 18 are activated jointly so that the load 40 remains aligned.

An automatic load balancing between the hoist cylinders 18 takes place through communication between the crawlers 10. As already mentioned, load measuring cells at each of the hoist cylinders 18 thereby capture the respective load and report them to the crawler controller 30 of each crawler 10. This data is interchanged via the interface 38. In FIG. 4 for example, if one of the involved crawlers 10 drives through a ground depression during transport, then the unloading of its hoist cylinder 18 is immediately identified and an activation is specified, which acts against this unloading so that the hoist cylinder 18 is extended until a balanced load is achieved.

FIG. 5a, 5b show as an example the transport of a very heavy load 40, in the shown example of a tripod for an offshore wind power plant. This transport task is solved by a network of crawlers 10. A load bearing point 48 (FIG. 5b) is thereby determined for each of the three legs of the tripod 40. The load of this load bearing point 48 is thereby distributed respectively to three crawlers 10, in that a support frame 50 is placed underneath, at which the load bearings 20 of the crawlers 10 engage.

A central point 52, which is always used as the reference point for the unit formed from the crawlers 10 and the load 40, is thereby identified on the load 40.

For the transport, the tripod 40 is first positioned upright at the place of manufacture, wherein the hoist frames 50 are placed on supports. The crawlers 10 are then moved up and positioned below the hoist frames 50. At the control command of the central controller, the respective crawler controllers 30 of the crawlers 10 activate the hoist cylinders 18 such that the hoist frames 50 are borne at the load bearings 20 and the entire load 40 is finally lifted.

The load lifted in this manner is now transported to the destination location by driving the crawlers 10. The central controller thus specifies the driving direction. The arrangement of the crawlers 10 below the load 40 is stored in the central controller. For a desired advancing of the load 40, the central controller gives each crawler 10 a drive command, which is transmitted via the interface 38. The drive command thereby includes for each crawler 10 a default value for the angle of rotation relative to the load bearing, i.e. a direction, in which the crawler then automatically aligns relative to the load.

In the case of a linear movement for correspondingly aligned crawler units, as shown e.g. in FIG. 5b, the crawlers 10 are thereby each activated evenly so that they all move linearly in the same direction and thus transport the load.

FIG. 6a-6c show alternatively a system for transporting the tripod 40, which manages with only three crawlers 10. A support frame 51, as is shown in greater detail in particular in FIG. 6c, is hereby positioned centrally below the tripod 40. The support frame 51 is formed from a triangle of tie bars 44, wherein a special bearing construction 53 is arranged on each corner of the triangle. Each of the bearing constructions 53 serves on one hand as a support for the mounting of cross members of the tripod 40 as shown in FIG. 6a, 6b and, on the other hand, is arranged under pressure between the corners of the triangle and the central support of the tripod 40, is thus supported in the centre on it respectively by supports 55.

A crawler 10 is arranged below each load bearing point on the bearing constructions 53. Thus, the three crawlers 10 shown in FIG. 6a-6c carry the load 40 together. Due to the three-point mounting designed in this manner, the network is stable and easily controllable, wherein the crawlers 10 are activated for uniform travel for moving the load 40.

Besides purely linear travel, considerably more complex driving maneuvers are also possible with a network of crawlers. FIG. 10 shows as an example a network of nine crawlers 10 below a load 40. An individual speed vector, i.e. a driving direction and a driving speed, is thereby specified for each crawler 10 by the central controller. The driving direction is thereby specified as the angle of rotation value relative to the load bearing, which is checked and adjusted by means of the angle sensor 27. The crawler controller 30 of each crawler 10 executes the corresponding drive command, in that it executes the rotation in the desired driving direction through different activation of the chain drive units and then causes the advancing with the specified speed through synchronized speed of the chain drive units. Thus, for instance in the example shown symbolically in FIG. 10, an arch with a right rotation is described overall by the load 40.

In the case of the control e.g. of the network in FIG. 5a, 5b, the uppermost load point 52 is the reference point for the entire network. All positioning processes refer to this point. An operator with an operating panel (connected with the central controller) specifies the drive commands for the transport of the load 40 but starting from its generally differing standpoint. According to the geometric arrangement of the respective crawlers 10, the central controller assumes the transformation of the drive commands. The operator specifies via the operating panel the speed and direction (speed vector) for the transport of the load, in relation to its standpoint. The central lubrication assumes the transformation of this vector into the reference system of the uppermost load point 52 and calculates the direction vectors necessary for the conversion for the load points of the next plane. The direction vectors of the load points of the underlying plane are then calculated respectively for these load points. This process continues until the load bearings 20 of the crawlers 10 are reached. The speed vectors calculated for the load bearings 20 are transmitted to the respective crawler controllers 30 of the crawlers 10, which then execute the positioning requirements.

FIG. 7a-7d show a specific implementation of a crawler 110 as a second embodiment. Elements that are identical to those in the first embodiment of a crawler 10 are thereby shown with the same reference numbers and are not explained separately again below.

The crawler 110, in which of the bearing unit 16 only the lifting unit with the hoist cylinder 18 with the load bearing 20 arranged on the end of the piston 19 is shown in FIG. 7a-7b, is designed for picking up loads of e.g. up to 320 t. The crawler has a length of approximately 4.8 m and a width of 3.14 m, with a track width of the chain drive units 12a, 12b of 60 cm.

The hoist cylinder 18 is completely integrated into the chassis and can still absorb up to 30% of the lateral forces in the extended state. In the example of the crawler with up to 320 t of load, a lateral force of up to 90 t is thus possible.

FIG. 8 shows separately the hoist cylinder 18 and piston 19 with the load bearing 20. The piston 19 thereby has (not shown in FIG. 8), as shown in the general design described above, a ball head 22, which is received in a socket 24 screwed to the load bearing 20 for formation of a ball and socket connection and is secured in a form-fitting manner by a locking ring 25. Rotational and swivel movements can then be executed between the piston 19 and the load bearing 20.

FIG. 8 shows the rotary sensor 27 for determining the angle of rotation between the piston 19 and the load bearing 20 with partially open housing 62. The housing 62 is connected in a swivel- and torque-proof manner with the piston 19.

A cardanic coupling 64 is attached to the load bearing 20 with an inner ring 66 and an outer ring 68. In a manner generally known for cardanic couplings, the inner ring thereby swivels with respect to the load bearing 20 around a horizontal first axis, but is thereby attached in a torque-proof manner. The outer ring 68 is in turn arranged in a swivelling manner on the inner ring 66 around a second horizontal axis, which is arranged less than 90 degrees to the first horizontal axis. The outer ring 68 is thus also coupled with the load bearing 20 in a torque-proof manner, thus following each rotational movement. The outer ring 68 is connected in a swivel-proof manner with the sensor housing 62.

Within the sensor housing 62, the outer ring 68 is coupled with a rotary disc 72 via a toothed belt 70.

For determining the rotary position of the load bearing 20 with respect to the piston 19, independently of swivel movements, only the determination of the rotary position of the rotary disc 72 with respect to the sensor housing 62 is thus to be determined. This is ensured in the preferred example by an inductive rotary sensor on a sprocket below the rotary disc 72 (not shown). After the impact of swivel movements is eliminated by the coupling via the cardanic connection 64 and the toothed belt 70, other types of generally known angle sensors can also be used here.

As already explained, the load bearing 20 can pick up a load 40 through pure placement, i.e. without a permanent connection particularly acting in both ways. In a particularly preferred embodiment, as shown in FIG. 9, a bearing device 74 for the load bearing 20 is formed on the load or a support frame 50, 51.

The bearing device 74 comprises a ring 76 with a projection 78, which engages in a corresponding groove of the load bearing 20 and thus secures the alignment of the load bearing 20 within the ring 76. The bearing device 74 is fastened on the load 40 or on a support frame 50. For connection with the load bearing 20, it is retracted from below into the ring 76 and then locked within the ring 76 by actuating a locking mechanism, designed in the example shown by radially shiftable locking elements 80 actuatable by an actuating rod 82. Due to the mounting in the ring 76, lateral forces can also be applied with respect to the load 40. Due to the locking by the locking elements 80, tractive forces can also be applied so that it is for example possible to lift the entire crawler 10 by retracting the piston 19.

The chain drive units 12a, 12b comprise respectively chassis 104 with chain wheels 106 arranged on the end side, one of which is respectively driven by a hydraulic motor 102. Rollers 108 are provided below the chassis 104. A drive chain 110 is placed around the chain wheels 106 and the rollers 108.

The chassis 14 is supported on the double-sided chassis 104 so that the forces absorbed at the bearing unit 16 are directed from the chassis 104 to the chain drive units 12a, 12b, which are supported via the drive rollers 108 with respect to the chain 110 and thus with respect to the ground surface. Thus, a structure with a high load-bearing capacity is created, in which the forces absorbed at the load bearing are distributed well to the driving surface of the chain 110.

For the drive, the crawler 110 has a central diesel drive. It is arranged in a power-pack housing 112. A six-cylinder engine (not shown separately) drives separate hydraulic pumps within the housing 112 via a transfer gearbox also arranged in the housing 112, with which on one hand the hoist cylinder 18 is supplied and on the other hand the hydraulic drives 102 of the chain drive units 12a, 12b are driven in a closed drive system. A hydraulic tank 114 is provided on board. Furthermore, a fuel tank 113 is also provided on board so that the crawler 110 is completely self-sufficient.

With a controller 30 provided on board, the pressure created by the hydraulic pumps is directed in a regulated manner to the hydraulic engines 102 of the chain drive units 12a, 12b as well as the hoist cylinder 18 via the activation of valves. A drive control is brought about by targeted activation of the engines 102.

The controller 30 on board is designed as a computer with a microprocessor and program and data memory, on which a control program runs, with which the described control and regulation functions, query of the sensors, communication with other controllers and/or a head controller, and the activation of the active units on board take place in real time.

Driving programs are saved in the program memory, which control respectively the behaviour of each individual crawler 10 within the network. Individual programs are thereby provided for different transport tasks and constellations of crawlers, which can be selected as suitable. A change in the driving programs is thereby always possible, for example by importing CAD data of the respective network. The position of the respective crawler within the network with other crawlers 110 at the common load 40 is thereby saved in the controller 30. The controller thus has the data for the relative positioning of the crawler with respect to the reference points 48, 52 of the load 40. Depending on the relative position and alignment, to be measured via the angle of rotation at the load bearing, the controller can thus determine the respectively desired speed vector for the advancing caused by the chain drive units 12a, 12b.

The controller thereby has on one hand pre-saved data records for operation in a network with other crawlers 110 according to different constellations, i.e. number and/or arrangement of crawlers 110. On the other hand, the operating program is preferably designed in a teachable manner so that configurations other than those first pre-saved can be used based on parameters measured and/or transmitted via the communication interface 38.

In summary, the controller 30 on board each crawler fulfils the following functions:
Monitoring of the position and alignment of the crawler in the plane (this is ensured in particular via the analysis of the rotary sensor 27 with respect to the specified speed vector as well as the activation of the chain drive units 12a, 12b, if necessary monitored by wheel sensors; additional sensors and functions such as gyro compass, GPS positioning, etc. can also be used in a supportive manner),
monitoring of the tilt of the crawler (by means of position sensors),
monitoring of the load individually carried by the crawler (by mans of load measuring cell on the hoist cylinder 18),
monitoring and regulation of the individual level of the load bearing point in relation to all other crawlers of the network (this is ensured by path sensors on the hoist cylinder 18, wherein the values are interchanged with other crawlers through communication via the interface 38),
ability to convert a driving vector (direction, driving speed) transmitted by a central controller into corresponding driving movements and to monitor the conversion,
monitoring of compliance with its own physical limits, e.g. maximum hoist height, maximum load, maximum speed or tilt.

The central controller for a network of crawlers 10 is programmable in relation to the design of the network structure, i.e. the position of the load bearing points of the individual crawlers in the network. Different network structures for different use cases can thereby be saved and called for the respective use. The controller preferably takes place via a device that can be carried by an operator, in which the drive commands (speed, direction) of the entire network are preferably specified via a joy stick and the operator receives notifications via displays.

For this, the central controller performs a continuous calculation and monitoring of the driving vector to be executed by each crawler 10 of the network during network travel. In the case of detected faults, the central controller triggers the immediate stop of all crawlers. Additionally, the central controller can monitor average wind speeds and directions and adjust through a corresponding opposite tilt of the load, brought about via the individual hoist height on the crawlers. As already explained, the central controller can specify at inclines a levelling of the load through individual control of the load bearings on the individual crawlers.

FIG. 12 shows another example of a network of crawlers 10 for transporting a disk-shaped concrete foundation (which is just shown by a ring shape for a better overview in FIG. 12).

In the case of the network 60 shown in FIG. 12, sixteen crawlers 10 are provided to lift the disk-shaped foundation 40 first from the sediment foundations 62, then to transport it to the destination location and finally to lower it there again on similar sediment foundations.

As shown schematically in FIG. 12, the total of sixteen crawlers 10 can thereby directly carry the load 40 without each support frame. For this, the crawlers 10 are positioned in the shown constellation below the load 40. Only a rubber disk is thereby placed on each of the load bearings 20 in order to ensure a better hold of the load. Optionally, the load bearings 20 can be connected by tie bars (now shown in FIG. 12).

The hoist cylinders of the crawlers 10 can then be controlled by the described central controller and the individual crawler controllers such that the load bearings 20 are driven from below against the load 40 and are thus lifted. The load 40 can then be moved freely by controlling the network 60 and finally lowered at the destination.

The invention is not restricted to the embodiments described above; rather they are to be understood as examples. Thus, in particular, the number and arrangement of crawlers 10, 110 in a network will depend greatly on the type of the respective load. The system according to the invention is thereby characterized in particular by the many possible fields of application and flexible use of the same crawlers in different configurations.

For example, a network of crawlers can be used for transporting counterweights of a crane. In this case, it is preferred that the crawlers 10, 110 are not only connected by one-sided mounting with the load 40 on the load bearing 20, but rather a connection that can also be pulled on is created by a permanent connection, e.g. screwed connection. The load to be transported, e.g. a counterweight, can then be lowered at the installation location on a mount or respectively a frame and the crawlers 10, 110 can be pulled in or respectively raised by pulling in the hoist cylinder 18.

Other different deviations from the embodiments described are possible. If necessary, the non-twistability of the hoist cylinder and/or the rotary sensor 27 on the load bearing 20 can be omitted, e.g. when the drive control and alignment with the load are otherwise ensured. In general, the examples shown here as well as the attached claims are to be understood such that the claimed characteristics as well as the described properties and elements of the respective embodiments can be used together in different combinations, whereas other elements can be omitted. The characteristics of claims that do not reference each other directly can also be used together in a meaningful combination.

1. A crawler for transporting loads with at least
two chain drive units,
a bearing unit between the chain drive units,
wherein the bearing unit has a load bearing for a load to be transported and a hoist cylinder having a piston for adjusting the height of the load bearing,
wherein the hoist cylinder and the piston are mounted to the bearing unit in a rotationally locked manner
and wherein the load bearing is coupled to the hoist cylinder by way of a ball and socket connection allowing a rotational and swivel movement between the load bearing and the bearing unit,
and a rotary sensor is provided in order to determine an angle of rotation between the load bearing and the piston or hoist cylinder.

2. The crawler according to claim 1, in which the piston is received in the hoist cylinder in a form-fitting manner with a non-round cross-section.

3. The crawler according to claim 1, in which the rotary sensor has a first sensor part, which is coupled with the hoist cylinder or the piston in a torque- and swivel-proof manner,
and a second sensor part, which is coupled with the load bearing in a torque- and swivel-proof manner,
wherein the second sensor part is arranged in a torque- and swivel-proof manner with respect to the first sensor part,
wherein the rotary sensor determines the angle of rotation between the first sensor part and the second sensor part.

4. The crawler according to claim 3, in which a coupling element is provided, which is arranged in a swivel-proof but rotatable manner with respect to a sensor part and in a torque-proof but swivelling manner with respect to the other sensor part.

5. The crawler according to claim 1, in which the rotary sensor has a cardanic coupling, in order to capture the angle of rotation independently of swivel movements of the ball and socket connection.

6. The crawler according to claim 1, in which the ball and socket connection has a locking element for form-fitting bearing of the ball.

7. The crawler according to claim 1, in which the hoist cylinder has a load sensor for determining the supported load.

8. The crawler according to claim 1, in which a control unit is provided for separate activation of the chain drive units and for the activation of the hoist cylinder.

9. The crawler according to claim 8, in which the control unit is connected with at least one of the rotary sensor, a lifting sensor, or a path sensor.

10. The crawler according to claim 1, in which a hydraulic system with a hydraulic pump is provided, and a propulsion motor is provided as a hydraulic motor respectively on the chain drive units,
wherein the propulsion motors and the hoist cylinder are operated with the hydraulic system.

11. A system for transporting loads with
a plurality of crawlers according to claim 1,
which transport a common load borne at the load bearings,
with communication devices in order to transmit sensor values and/or control commands between the crawlers amongst each other and/or between the crawlers and a head controller.

12. The system according to claim 11, in which control values for the angle of rotation are transmitted to the crawlers, wherein the controller of the crawlers is designed such that it activates the chain drive units such that the control value of the angle of rotation at the load bearing is reached.

13. The system according to claim 11, in which the crawlers have a load sensor for the load of the hoist cylinders, and the hoist cylinders are activated such that load deviations are counterbalanced.

14. The system according to claim 11, in which a position sensor for the load is provided, wherein the hoist cylinders of the crawlers are activated such that the position of the load is counterbalanced.

15. A method for transporting loads, in which
a load is borne jointly at the load bearings of a plurality of crawlers according to claim 1,
and control commands are transmitted to the crawlers in order to transport the load through joint activation of the chain drive units.

16. The crawler according to claim 1, in which the hoist cylinder has a path sensor for determining the stroke travel.
